(19) United States
(12) Patent Application Publication
(10) Pub. No.: US 2002/0123308 A1
(43) Pub. Date: Sep. 5, 2002

(54) Suppression of periodic interference in a communications system

(76) Inventor: Alberto Jimenez Feltstrom, Loberod (SE)

Correspondence Address: Spencer C. Patterson, Jenkens & Gilchrist, P.C., 1445 Ross Avenue, Suite 3200, Dallas, TX, 75202-2799, US

(21) Appl. No.: 09/757,755

(22) Filed: Jan. 9, 2001

(51) Int. Cl. H04B 1/10

(52) U.S. Cl. 455/63; 455/423; 455/67.3

(57) ABSTRACT

Methods, systems, and arrangements enable the generation of a replica of periodic interference that is disturbing a desired signal so as to subtract out an estimation of the periodic interference from the infected signal. In certain embodiments, a speech signal from a microphone of a mobile station is infected with “bumblebee” noise. In accordance with the present invention, a received signal includes a desired and an interfering component. The received signal is bandpass filtered around the expected frequency of the interfering component, and a fundamental frequency thereof may thereafter be ascertained. Harmonics of the fundamental frequency are generated so as to reconstruct an estimate of the interfering component in the frequency domain using determined weights and Fourier series theory. The interfering component estimate is subtracted from the received signal to determine a desired component estimate. The weights may be optionally adjusted in a feedback loop.

### BACKGROUND OF THE INVENTION

1. Technical Field of the Invention

The present invention relates in general to the field of communications systems, and in particular, by way of example but not limitation, to identifying and suppressing periodic interference (e.g., noise) in digital wireless communications systems.

2. Description of Related Art

Access to wireless networks is becoming increasingly important and popular for business, social, and recreational purposes. Users of wireless networks now rely on them for both data exchanges and voice conversations. An ever increasing number of users demand both an increasing array of data services and capabilities as well as clearer voice communications. One aspect of wireless communications systems that needs to be addressed to improve the quality of voice communications when using wireless mobile stations (MSs) is the existence of interfering noises caused by or related to the MSs themselves. One such interfering noise that must commonly be accounted for is the so-called “bumblebee” noise, which can hamper the ability of wireless networks to provide crystal-clear voice communications.

This “bumblebee” interference on the microphone signal of MSs is one problem that faces designers when developing new MSs. The interference appears as an audible periodic signal with a particular fundamental frequency that is added to the speaker signal. This “bumblebee” sound is associated with certain mobile phones and is noise that is generated by the switching nature of Time Division Multiple Access (TDMA) communications systems (e.g., cellular telephony systems). For example, in Global System for Mobile Communications (GSM) systems, the TDMA radio circuits are switched on and off at a rate of approximately 217 Hz. Signals at this base frequency, as well as its harmonic frequencies, are coupled into the analog microphone signal in the MS, which produces an annoying bumblebee noise in the speech signal on uplink transmissions.

In existing wireless systems, this bumblebee noise is suppressed, filtered, and/or avoided using various techniques. However, while there are several techniques to combat the bumblebee interference, each suffers from one or more deficiencies. For example, one common approach is to carefully lay-out the printed circuit board (PCB). Good PCB layouts may be accomplished by keeping microphone wires short, by keeping microphone wires away from parts of the electronics that produce high interference, by properly by-passing audio components, etc. A more sophisticated approach to combat this bumblebee interference is the employment of linear filtering techniques. The bumblebee interference may be filtered out using a comb filter with notches situated at the fundamental frequency of the interference and harmonic frequencies thereof. Adaptive filters (e.g., “long term predictive” filters) may be used because periodic signals are correlated in the long term.

Unfortunately, these and other conventional techniques and approaches suffer from deficiencies. For instance, good PCB design is extraordinarily cumbersome. There are no “standard” strategies or recipes that work well for all PCB designs. Consequently, trial-and-error work is required to determine an optimum layout; such trial-and-error work is of course costly in terms of both money and time. As another instance, a comb filter and an adaptive linear filter do not filter only the interfering (e.g., noise) signal(s). These filters also remove a part of the desired audio (e.g., speech) signal, which causes the desired audio to be distorted.

### SUMMARY OF THE INVENTION

The deficiencies of the prior art are overcome by the methods, systems, and arrangements of the present invention. For example, as heretofore unrecognized, it would be beneficial if bumblebee and/or other interfering noises could be reduced or eliminated easily, cheaply, and without distorting the desired (e.g., speech) signal. In fact, it would be beneficial if a replica of the interfering signal could be generated and thereafter subtracted from the overall (e.g., microphone) signal to thereby produce the desired signal.

In accordance with certain embodiment(s) of the present invention, a replica of the interfering signal may be generated and thereafter subtracted from the overall (e.g., microphone) signal to thereby produce the desired signal without distortion of the desired signal. In certain exemplary embodiment(s) relating to, for example, an MS in a wireless network, a received signal includes a speech and a noise component. The received signal may be bandpass filtered in a frequency range around a frequency at which noise is expected to be found. From the bandpass filtered output, an accurate value of the fundamental frequency of the noise may be ascertained. Harmonics of the fundamental frequency may then be generated. In accordance with Fourier series theory, a frequency-domain estimation of the noise is generated by attaching corresponding weights to each of the frequency harmonics, as well as the fundamental frequency.

The noise estimate is subtracted from the received signal to arrive at an estimate of the speech signal. The speech signal may then be forwarded for further processing. To further refine the noise handling scheme, the speech signal estimate may be optionally fed back through a set of bandpass filters, each bandpass filter of which is centered on a harmonic frequency of the noise. The outputs of the optional bandpass filter set may be analyzed and the weights of the Fourier series sum adjusted accordingly. It should be understood that the principles of the present invention are also applicable to signals in general that are disturbed by interfering signals in general.

The above-described and other features of the present invention are explained in detail hereinafter with reference to the illustrative examples shown in the accompanying drawings. Those skilled in the art will appreciate that the described embodiments are provided for purposes of illustration and understanding and that numerous equivalent embodiments are contemplated herein.

### BRIEF DESCRIPTION OF THE DRAWINGS

A more complete understanding of the methods, systems, and arrangements of the present invention may be had by reference to the following detailed description when taken in conjunction with the accompanying drawings wherein:

FIG. 1 illustrates an exemplary portion of an exemplary wireless communications system with which the present invention may be advantageously practiced;

FIG. 2 illustrates a block diagram of an exemplary mobile station that may be used to implement certain embodiment(s) in accordance with the present invention;

FIG. 3 illustrates an exemplary graph in the frequency plane of a signal with a periodic disturbance at a fundamental frequency and harmonics thereof;

FIG. 4 illustrates a block diagram of an exemplary interference handler in accordance with the present invention; and

FIG. 5 illustrates an exemplary method in flowchart form for handling interference in accordance with the present invention.

### DETAILED DESCRIPTION OF THE DRAWINGS

In the following description, for purposes of explanation and not limitation, specific details are set forth, such as particular circuits, logic modules (implemented in, for example, software, hardware, firmware, some combination thereof, etc.), techniques, etc. in order to provide a thorough understanding of the invention. However, it will be apparent to one of ordinary skill in the art that the present invention may be practiced in other embodiments that depart from these specific details. In other instances, detailed descriptions of well-known methods, devices, logical code (e.g., hardware, software, firmware, etc.), etc. are omitted so as not to obscure the description of the present invention with unnecessary detail.

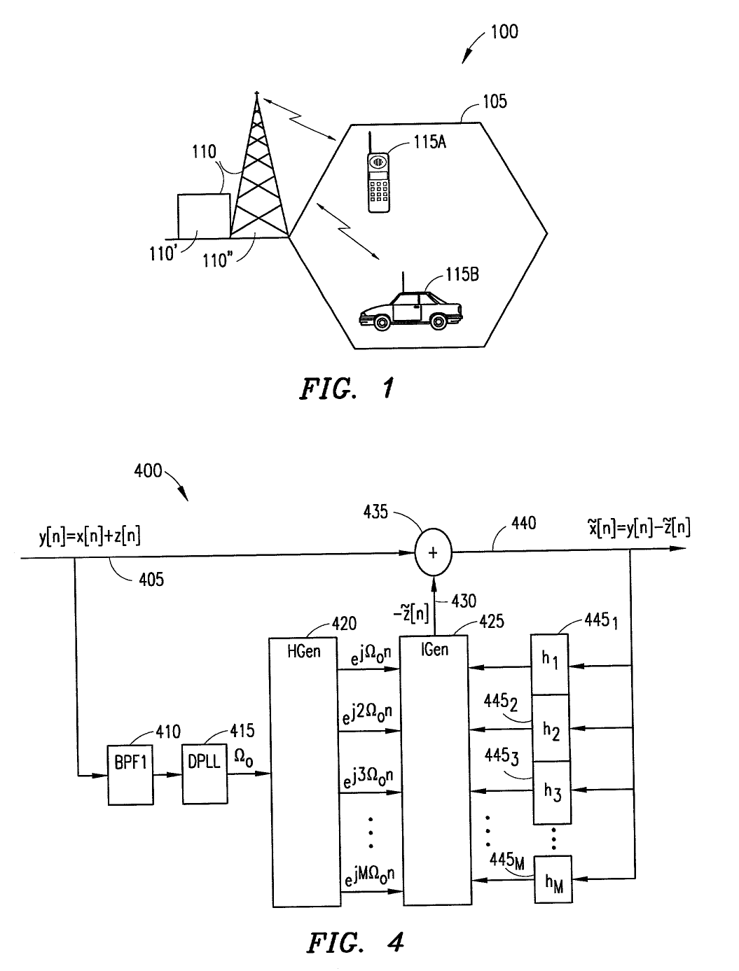

A preferred embodiment of the present invention and its advantages are best understood by referring to FIGS. 1-5 of the drawings, like numerals being used for like and corresponding parts of the various drawings. Aspects of the Global System for Mobile Communications (GSM) standard that is widely used in Europe are used to describe embodiments of the present invention. However, it should be understood that the principles of the present invention are not so limited and are applicable to other wireless communication standards (or systems) (e.g., the Personal Digital Cellular System (PDC) in Japan, the Digital-Advanced Mobile Phone System (D-AMPS) in North America, etc.). The principles of the present invention are especially applicable, for example, to those standards or systems in which suppression of bumblebee noise or similar types of noise(s) is at issue.

With reference now to FIG. 1, an exemplary portion of an exemplary wireless communications system with which the present invention may be advantageously practiced is illustrated generally at 100. The (portion of) wireless communications system 100 includes a cell 105 that is served by a base station (BS) 110. The BS 110 may be composed of or affiliated with a radio base station (RBS) 110″ (e.g., a base transceiver station (BTS) in GSM), a radio network controller (RNC) 110′ (e.g., a base station controller (BSC) in GSM), and/or other network-side components of the wireless communications system 100. Within the cell 105 are multiple MSs 115A and 115B, each of which may be in communication with the wireless network infrastructure as represented by the BS 110. Each MS 115 may be, for example, a hand-held cellular phone (e.g., the MS 115A), a vehicle-mounted MS (e.g., the MS 115B), a data terminal with a wireless link (not specifically shown), etc. While only two MSs 115 are shown in the wireless communications system 100, many more MSs 115 are usually present within a cell 105. Also, it should be noted that the wireless communications system 100 is usually composed of many such cells 105, BSs 110, etc.

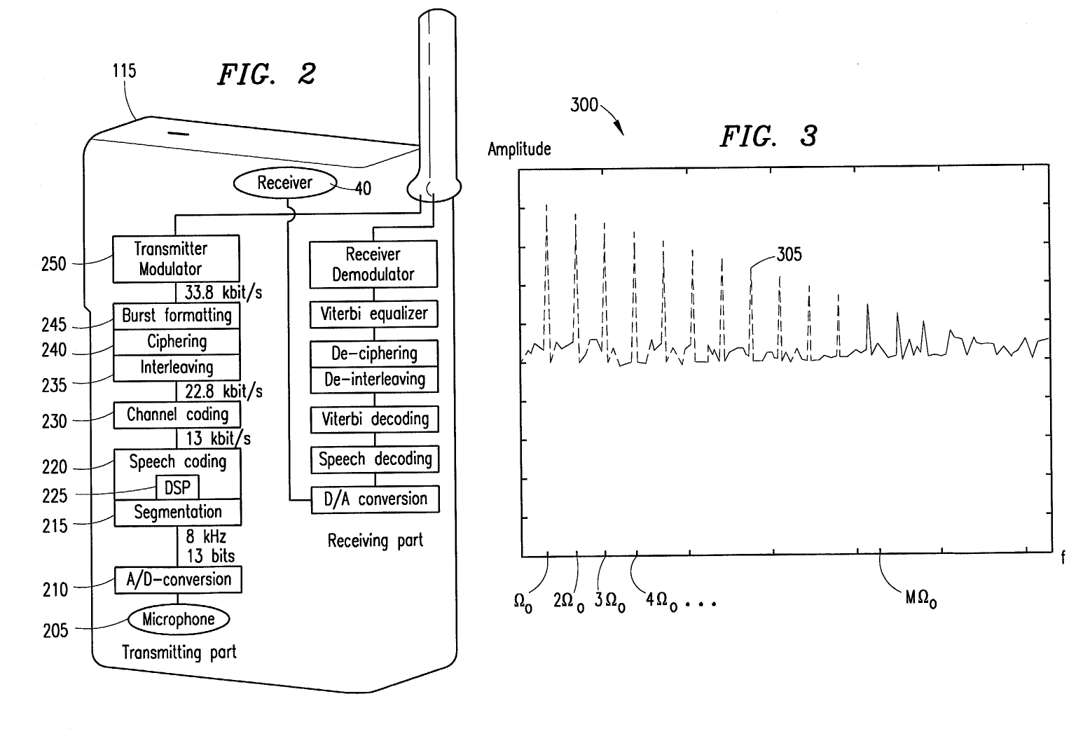

With reference now to FIG. 2, a block diagram of an exemplary mobile station that may be used to implement certain embodiment(s) in accordance with the present invention is illustrated generally at 115. The MS 115 includes a transmitting part (illustrated on left) and a receiving part (illustrated on right). It should be noted that many other alternative implementations are possible within the scope of the present invention. For this exemplary embodiment, the present invention may be implemented in the transmitting part of the MS 115. Consequently, the following description is directed to the transmitting part of the MS 115. As such, an analog (e.g., speech) signal from a microphone 205 is digitized by an analog-to-digital (A/D) converter 210. A segmentation unit 215 divides the digitized speech signal into 20 ms segments (e.g., in exemplary GSM embodiment(s)), which are coupled to a speech coder 220. A function of the speech coder 220 is to reduce the bit rate of the digitized speech signals in order for the resulting speech channels to be able to stay within the allowed frequency band. It should be noted that the exemplary bit rates as illustrated are per physical channel.

In certain embodiment(s), a processing unit 225 (e.g., a digital signal processor (DSP), a similar type of digital processor, a general purpose processor, etc. operating as part of or in conjunction with hardware, software, and/or firmware, etc.) is associated with the speech coder 220 to receive the incoming stream of speech samples (e.g., as sampled by the speech coder 220 at an exemplary 8 kHz). The processing unit 225, in accordance with certain embodiment(s) of the present invention, accepts the speech signal that includes the desired speech signal as well as a bumblebee noise component. The processing unit 225 creates an estimate of the bumblebee noise component (e.g., using Fourier Series Theory) and thereafter subtracts the estimate of the bumblebee noise component from the speech signal to produce an estimate of the desired speech signal. A feedback loop enables the processing unit 225 to fine tune the estimation (e.g., the replica) of the bumblebee noise component and thus the production of the estimation of the desired speech signal. The (e.g., estimate of the desired) speech signal(s) may then be channel coded by the channel coding unit 230, interleaved by the interleaving unit 235, encoded by the ciphering unit 240, burst formatted by the burst formatting unit 245, and modulated and transmitted from the MS 115 by the transmitter modulator 250 over appropriate uplink channel(s).

With reference now to FIG. 3, an exemplary graph in the frequency plane of a signal with a periodic disturbance at a fundamental frequency and harmonics thereof is illustrated generally at 300. The graph 300 plots the signal 305 with frequency versus amplitude. As indicated by the legend along the x-axis (abscissa), the decreasing amplitude spikes in the signal 305 start at Ω₀ and occur at every multiple of Ω₀ until the amplitude spikes reach an amplitude at or after MΩ₀ that may be discounted/ignored because they are of sufficiently negligible amplitude. Advantageously, if Ω₀ equals the bumblebee frequency of 217 Hz and iΩ₀ are harmonics thereof (where i_{MAX}=M), then application of the principles of the present invention reduce or eliminate the amplitude spikes in the signal 305.

With reference now to FIG. 4, a block diagram of an exemplary interference handler in accordance with the present invention is illustrated generally at 400. The interference handler 400 represents one way to generate a replica of the interference and thereafter subtract it from the received (e.g., from the microphone) signal to produce an approximation of the desired (e.g., speech/audio) signal. It should be understood that alternative implementation(s)/embodiment(s) are within the scope of the present invention. With the interference handler 400, a signal y[n] 405 is received. The signal y[n] is composed of at least two components, a desired signal x[n] and an interference signal z[n]. In certain embodiment(s), signal y[n] may correspond to a signal composed of desired uplink audio signal x[n] that is disturbed by interference signal z[n].

The signal y[n] is applied to a bandpass filter (BPF1) 410 that permits only signal portions in the relevant frequency range (e.g., around 217 Hz when attempting to handle bumblebee interference in GSM-based systems) to pass through. The resulting bandpass filtered signal is applied to a digital phase locked loop (DPLL) 415 to ascertain an accurate value of the fundamental frequency Ω₀ of the interference (e.g., of the signal z[n]). Because the BPF1 410 only passes the relevant frequency range of the signal y[n], the DPLL 415 may determine the fundamental frequency Ω₀ with greater accuracy. This fundamental frequency Ω₀ is forwarded from the DPLL 415 to a harmonic generator (HGen) 420. Using the fundamental frequency Ω₀, the HGen 420 generates M harmonics. The M harmonics e^{jnΩo} are forwarded from the HGen 420 to an interference generator (IGen) 425.

According to Fourier Series Theory, periodic signals can be decomposed into a sum of harmonics with different amplitudes. Conversely, a sum of weighted harmonics can reconstruct any periodic signal (to a given level of accuracy). The degree of accuracy of the reconstruction depends on the number of terms used in the sum. In the particular exemplary embodiment(s) represented by the interference handler 400, the number of terms in the sum is M. The task of the IGen 425 is therefore to find a set of weights wᵢ (with i=1, 2, 3, . . . , M) so as to reconstruct the interference replica (e.g., to estimate the interference signal z[n]) by:

$$\tilde{z} [ n ] = {\sum }_{i = 1}^{M} {w}_{i} {ⅇ}^{j i {Ω}_{0} n} .$$

The negative of the estimate of the interference signal \tilde{z}[n] 430 is input to a summer 435 along with the received signal y[n] 405. The output of the summer 435 is an estimate of the desired signal \tilde{x}[n] 440. (Specifically, the estimate of the desired signal \tilde{x}[n] 440 is equivalent to the received signal y[n] 405 minus the estimate of the interference signal \tilde{z}[n] 430 in the exemplary interference handler 400.)

In certain embodiment(s), this estimate of the desired signal \tilde{x}[n] 440 may be optionally input to a set of bandpass filters hᵢ (with i=1, 2, 3, . . . , M) 445₁ . . . 445_{M}. Each of the bandpass filters hᵢ 445₁ . . . 445_{M} has a center frequency of iΩ₀. The outputs of the respective bandpass filters hᵢ 445₁ . . . 445_{M} are provided to the IGen 425. The IGen 425 determines a measure of similarity between the resulting interference replica \tilde{z}[n] and the actual interference signal z[n], which is part of the received signal y[n] 405. The IGen 425 can then adjust the weights wᵢ using any of many algorithms, such as a steepest descend algorithm like the Least Mean Square (LMS) algorithm, for example.

In other words, the weights wᵢ in the Fourier series may be determined iteratively (e.g., sample by sample) using the LMS algorithm, for example. The LMS algorithm may be expressed as:

$${w}_{i} [ n ] = {w}_{i} [ n - 1 ] - μ e [ n ] \frac{ⅆ e [ n ]}{ⅆ {w}_{i} [ n - 1 ]} ,$$

where wᵢ[n] is the ith weight coefficient at time n with μ as an adaptation rate constant. (A best or preferred initial value of the weights wᵢ may be determined empirically.) The variable e[n] represents the error signal during speech. In these alternative embodiment(s), instead of relying on a set of bandpass filters 445, the similarity between the estimated interference replica \tilde{z}[n] and the actual interference signal z[n] may be determined by computing the following error signal during speech:

e[n]^{def}=z[n]−\tilde{z}[n].

A Voice Activity Detector (VAD) (not shown) may be used to detect when there is speech in the signal y[n]. The output of the VAD may therefore be used to determine when the weights wᵢ should be updated (e.g., when the VAD is detecting speech, the adaptation rate should be set to a lower rate (or even zero)).

Regardless of the implementation of the feedback loop, the output of the interference handler 400 is the estimate of the desired signal \tilde{x}[n] (e.g., the speech signal). This estimate of the desired signal \tilde{x}[n] approaches the actual desired signal x[n] if the IGen 425 successfully determines (or achieves a close estimation of) the correct weights wᵢ. In other words, the IGen 425 preferably reconstructs a perfect or near perfect replica (i.e., \tilde{z}[n]=z[n]).

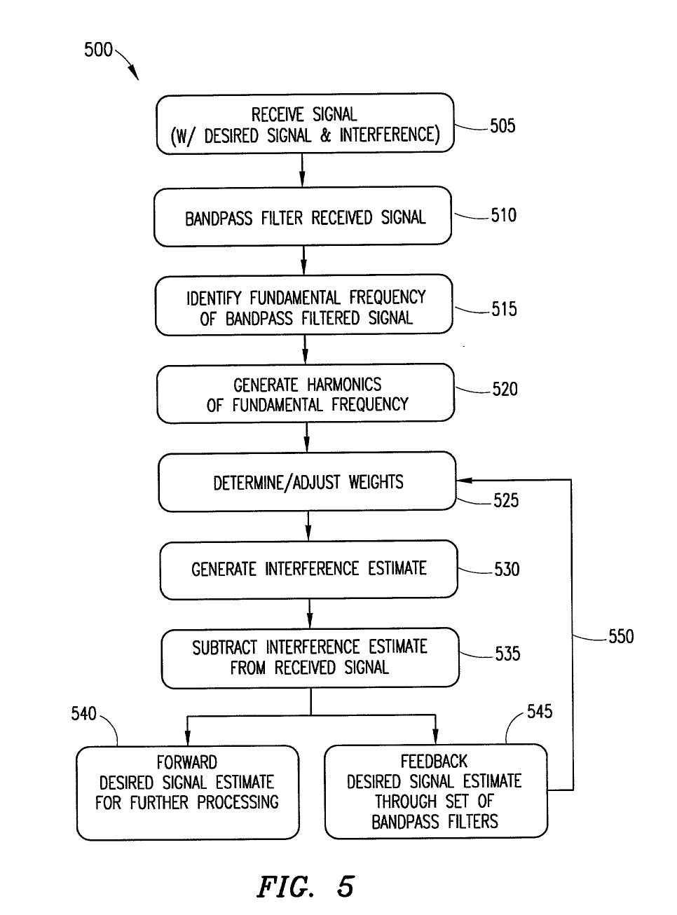

With reference now to FIG. 5, an exemplary method in flowchart form for handling interference in accordance with the present invention is illustrated generally at 500. The flowchart 500 commences as a signal is received (step 505). The received signal includes both a desired signal component and an interference component. The received signal is bandpass filtered (step 510) to narrow the signal to a targeted frequency range around an expected fundamental frequency. From the bandpass filtered signal, the fundamental frequency is identified (step 515) (e.g., using a digital PLL). A number of harmonics are generated from the fundamental frequency (step 520). Using Fourier theory analysis, for example, weights corresponding to respective harmonic frequencies (as well as the fundamental frequency) are determined (step 525). The weights and corresponding frequencies are utilized in the frequency domain to generate an estimate of the interference component (step 530).

The difference between the received signal and the interference component estimate is determined (e.g., by subtraction, addition of a negative, etc. at, for example, an arithmetic unit) (step 535). The difference determination results in an estimate of the desired signal component. This desired signal component estimate may be forwarded (e.g., to another device, module, routine, etc. within the MS) for further processing prior to transmission (step 540). This desired signal component estimate may also, in certain optional alternative(s), be fed back through at least a portion of the interference handling scheme by applying it to a set of bandpass filters (step 545). Each bandpass filter in the set of bandpass filters may be centered on a respective frequency corresponding to the fundamental frequency and harmonics thereof. After the desired signal component estimate has been bandpass filtered at the relevant harmonics (e.g., in an optional alternative), the results are provided (via arrow 550) so as to enable the adjustment of the weights that are applied to generate the interference component estimate (at step 525). The flowchart 500 may continue thereafter with the generation of a new estimate of the interference component (at step 530).

The principles of the present invention thus enable the discrimination of a noise component (e.g., a bumblebee interference signal) of a received signal (e.g., from a microphone of an MS) without distorting the desired component (e.g., the audio/speech signal). Advantageously, the hardware cost is low. In fact, because there is already at least one DSP or other processor in the MS, only some additional coding (e.g., DSP software) may be necessary to implement certain embodiment(s). Consequently, the implementation cost is negligible when employing the principles of the present invention to reduce or eliminate the so-called “bumblebee” noise with respect to, for example, MSs operating in digital TDMA wireless networks.

Although preferred embodiment(s) of the methods, systems, and arrangements of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the spirit and scope of the present invention as set forth and defined by the following claims.

What is claimed is:

1. A method for handling interference that is disturbing a desired signal, comprising the steps of:
receiving a signal, the signal including a desired component and an interference component;
estimating the interference component to produce an interference component estimate;
applying the interference component estimate to the signal to produce a desired component estimate;
forwarding the desired component estimate;
feeding back the desired component estimate; and
using the desired component estimate to adjust the interference component estimate.

2. The method according to claim 1, wherein the interference comprises “bumblebee” interference.

3. The method according to claim 2, wherein the “bumblebee” interference comprises a signal oscillating at approximately 217 Hz in a wireless network operating in accordance with the Global System for Mobile Communications (GSM).

4. The method according to claim 1, wherein said step of receiving a signal comprises the step of receiving the signal directly or indirectly from a microphone of a mobile station.

5. The method according to claim 1, wherein said step of estimating the interference component to produce an interference component estimate comprises the step of bandpass filtering the signal in a predetermined frequency range that is associated with the interference component.

6. The method according to claim 1, wherein said step of estimating the interference component to produce an interference component estimate comprises the step of identifying a fundamental frequency of the interference component.

7. The method according to claim 1, wherein said step of estimating the interference component to produce an interference component estimate comprises the step of generating harmonics of a fundamental frequency of the interference component.

8. The method according to claim 1, wherein said step of estimating the interference component to produce an interference component estimate comprises the step of generating a replica of the interference component in the frequency domain using harmonics of a fundamental frequency of the interference component.

9. The method according to claim 8, wherein said step of estimating the interference component to produce an interference component estimate further comprises the step of forwarding a time domain version of the replica as the interference component estimate.

10. The method according to claim 8, wherein said step of generating a replica of the interference component in the frequency domain using harmonics of a fundamental frequency of the interference component comprises the step of determining a weight for each addend of a Fourier series expansion, each addend corresponding to a harmonic of the fundamental frequency of the interference component.

11. The method according to claim 1, wherein said step of applying the interference component estimate to the signal to produce a desired component estimate comprises the step of subtracting the interference component estimate from the signal to produce the desired component estimate.

12. The method according to claim 1, wherein said step of forwarding the desired component estimate comprises the step of forwarding the desired component estimate for further pre-transmission processing in a mobile station.

13. The method according to claim 1, wherein said step of feeding back the desired component estimate comprises the step of submitting the desired component estimate to a plurality of bandpass filters, each bandpass filter of the plurality of bandpass filters being centered on a harmonic frequency of a fundamental frequency of the interference component.

14. The method according to claim 1, wherein said step of using the desired component estimate to adjust the interference component estimate comprises the step of adjusting a plurality of weights, each weight of the plurality of weights corresponding to an addend of a Fourier series sum, each addend of the Fourier series sum corresponding to a harmonic of a fundamental frequency of the interference component.

15. An arrangement for handling interference, comprising:
a fundamental frequency identifier, said fundamental frequency identifier adapted to accept a version of a signal, the signal including a desired component and an interference component, said fundamental frequency identifier further adapted to produce a fundamental frequency of the interference component;
a harmonic generator, said harmonic generator adapted to receive the fundamental frequency of the interference component and to generate harmonics thereof;
an interference generator, said interference generator adapted to receive the generated harmonics and to create a replica of the interference component; and
a difference determiner, said difference determiner adapted to receive the signal and the replica of the interference component and to determine the difference between the signal and the replica of the interference component to produce an estimate of the desired component.

16. The arrangement according to claim 15, further comprising:
a bandpass filter, said bandpass filter having a frequency range set responsive to an expected value of the fundamental frequency of the interference component, said bandpass filter adapted to receive the signal and to produce the version of the signal, the version of the signal being reduced in frequency spectrum in accordance with the frequency range of the bandpass filter.

17. The arrangement according to claim 15, wherein said fundamental frequency identifier comprises a phase locked loop (PLL).

18. The arrangement according to claim 15, wherein said interference generator is further adapted to create the replica of the interference component in the frequency domain using determined weights for a Fourier series expansion, the replica of the interference component comprising an interference component estimate.

19. The arrangement according to claim 15, wherein said difference determiner comprises a summer, said summer adapted to add a negative of the replica of the interference component to the signal to produce the estimate of the desired component.

20. The arrangement according to claim 15, further comprising:
a plurality of bandpass filters, each bandpass filter of said plurality of bandpass filters being centered on a harmonic of the harmonics of the interference component, said plurality of bandpass filters adapted to receive the estimate of the desired component and to produce a plurality of bandpass filtered outputs, each bandpass filtered output of the plurality of bandpass filtered outputs having a frequency spectrum centered around one of the harmonics of the interference component.

21. The arrangement according to claim 20, wherein said interference generator is further adapted to adjust weights of a frequency domain sum of addends responsive to the plurality of bandpass filtered outputs.

22. The arrangement according to claim 15, wherein the arrangement comprises at least part of a mobile station.

23. The arrangement according to claim 15, wherein at least part of at least one of said fundamental frequency identifier, said harmonic generator, said interference generator, and said difference determiner comprises software code.

24. A system for handling interference that is disturbing a desired signal, comprising:
means for receiving a signal, the signal including a desired component and an interference component;
means for estimating the interference component to produce an interference component estimate;
means for applying the interference component estimate to the signal to produce a desired component estimate;
means for feeding back the desired component estimate; and
means for using the desired component estimate to adjust the interference component estimate.

25. A method for handling interference that is disturbing a desired signal, comprising the steps of:
providing a signal, the signal including a desired component and an interference component;
filtering the signal to produce a bandpass filtered signal, the bandpass filtered signal having a frequency range selected responsive to an expected fundamental frequency of the interference component;
determining a fundamental frequency of the interference component from the bandpass filtered signal;
generating harmonics of the fundamental frequency of the interference component;
estimating the interference component to produce an interference component estimate using the fundamental frequency and the generated harmonics; and
applying the interference component estimate to the signal to produce a desired component estimate.

26. The method according to claim 25, further comprising the steps of:
feeding back the desired component estimate through a plurality of bandpass filters to produce a plurality of bandpass filtered outputs; and
using the plurality of bandpass filtered outputs to adjust the interference component estimate.

27. The method according to claim 25, further comprising the steps of:
feeding back the desired component estimate through an error determiner to determine an error of the interference component estimate; and
using the error to adjust the interference component estimate.

28. The method according to claim 27, further comprising the step of:
detecting an absence of voice activity in the signal; and
wherein said steps of feeding back the desired component estimate through an error determiner to determine an error of the interference component estimate and using the error to adjust the interference component estimate are executed responsive to the detection of the absence of voice activity in said step of detecting an absence of voice activity in the signal.

29. The method according to claim 27, wherein said step of using the error to adjust the interference component estimate comprises the step of iteratively adjusting weights in a Fourier series expansion.

30. An arrangement for handling interference comprising:
a filter, said filter receiving a signal as input, said filter outputting a filtered version of the signal, the signal including first and second components;
a frequency determiner, said frequency determiner coupled to said filter and receiving the filtered version of the signal as input, said frequency determiner outputting a frequency of the filtered version of the signal;
a harmonic generator, said harmonic generator coupled to said frequency determiner and receiving the frequency of the filtered version of the signal as input, said harmonic generator outputting a plurality of harmonics of the frequency of the filtered version of the signal;
a component generator, said component generator coupled to said harmonic generator and receiving the plurality of harmonics as input, said component generator outputting an estimate of the second component of the signal;
a difference determiner, said difference determiner coupled to said component generator and receiving the estimate of the second component and the signal as inputs, said difference determiner determining a difference between the signal and the estimate of the second component, the difference comprising an estimate of the first component of the signal.

31. The arrangement according to claim 30, further comprising:
a plurality of filters, said plurality of filters receiving the estimate of the first component as input, said plurality of filters producing a plurality of respective filtered outputs; and
wherein said component generator adjusts the estimate of the second component of the signal responsive to the plurality of respective filtered outputs in the frequency domain using at least one Fourier series expansion.

32. The arrangement according to claim 30, further comprising:
an error determiner, said error determiner receiving the estimate of the first component and the signal as inputs, said error determiner determining an error output; and
wherein said component generator adjusts the estimate of the second component of the signal responsive to the error output in the frequency domain using at least one Fourier series expansion when the first component is approximately zero.

33. A mobile station for handling bumblebee interference, comprising:
an antenna;
a transmitting part connected to said antenna, said transmitting part including a microphone having a microphone signal, the microphone signal infected by the bumblebee interference;
a receiving part connected to said antenna;
a processing unit, said processing unit adapted to receive at least a version of the microphone signal; and
wherein said processing unit is configured to estimate the bumblebee interference based, at least in part, on an expected fundamental frequency of the bumblebee interference and the at least a version of the microphone signal, said processing unit being further configured to subtract the estimate of the bumblebee interference from the at least a version of the microphone signal.
